(19) United States
(12) Patent Application Publication
(10) Pub. No.: US 2007/0188140 A1
(43) Pub. Date: Aug. 16, 2007

(54) Charging-discharging control device

(76) Inventor: Sheng-Feng Chen, Linkou Hsiang (TW)

Correspondence Address: RABIN & BERDO, P.C., Suite 500, 1101 14 Street N.W., Washington, DC, 20005, US

(21) Appl. No.: 11/444,419

(22) Filed: Jun. 1, 2006

(30) Foreign Application Priority Data
Feb. 16, 2006 (TW) 95105258

(51) Int. Cl. H02J 7/00

(52) U.S. Cl. 320/128

(57) ABSTRACT

A charging-discharging control device has a selector, a charging circuit and at least two battery packs. The selector has a controller and a discharging switch. When a controller input voltage is higher than a preset voltage, the controller generates a charge-discharge signal of a first voltage level, and when the controller input voltage is not higher than the preset voltage, the controller generates the charge-discharge signal of a second voltage level, and the discharging switch is turned on. The charging circuit coupled to the selector. When the charge-discharge signal is at the first voltage level, the charging circuit charges the battery packs. When the charge-discharge signal is at the second voltage level, the battery packs supply the power to a loading system.

### RELATED APPLICATIONS

The present application is based on, and claims priority from, Taiwan Application Serial Number 95105258, filed Feb. 16, 2006, the disclosure of which is hereby incorporated by reference herein in its entirety.

### BACKGROUND

1. Field of Invention

The present invention relates to a charging-discharging control device that can control several battery packs. More particularly, the present invention relates to a charging-discharging control device with low cost and high efficiency.

2. Description of Related Art

Portable devices are now abundant. For example, digital cameras, portable computers, personal digital assistants (PDA), and mobile phones are very popular portable devices. The battery packs are important power supply parts for portable devices. In order to lengthen the time the battery pack can be used, two battery packs connected in parallel are usually be used. Therefore, a charging-discharging control device to control these two battery packs is needed.

FIG. 1 is a functional block diagram depicting a charging-discharging control device of the prior art, wherein the charging-discharging control device is arranged to control the battery pack to charge and discharge. In FIG. 1, an AC/DC converter 100 is coupled to a selector 150 through a charging circuit 101 to select a first battery pack 120 and a second battery pack 130 to be charged or to discharge. The first battery pack 120 and the second battery pack 130 can supply the power to the loading system 199 through the selector 150 and a DC/DC converter 135.

The selector 150 has eight transistors 160, 165, 170, 175, 180, 185, 190 and 195. Every two transistors with different current directions are traditionally connected in series to form a switch. The switch can be completely turned off to isolate the influence between different charging-discharging paths. For example, the transistor 160 and 165 form a first switch which is controlled by a control signal C11, the transistor 170 and 175 form a second switch which is controlled by a control signal C12, the transistor 180 and 185 form a third switch which is controlled by a control signal C13, the transistor 190 and 195 form a fourth switch which is controlled by a control signal C14. Therefore, the first and the third switch control is a charging-discharging path of the first battery pack 120; the second and the fourth switch control is a charging-discharging path of the second battery pack 130.

The control module 155 in the selector 150 provides the control signals C11, C12, C14 and C14. For example, when the first battery pack 120 is charged, the control signal C11 turns on the first switch. When the second battery pack 130 discharges, the control signal C14 turns on the fourth switch.

FIG. 2 is a functional block diagram depicting a battery pack of the prior art. The first battery pack 120 has a battery connector 260 coupled to the selector 150, a switch 271 coupled to the connector 260, a switch 272 coupled to the switch 271, a battery 290 coupled to the switch 272, and a protector 280 respectively coupled to the switch 271 and the switch 272. The switch 271 is controlled by a first protector signal 266 to be turned on or turned off; the switch 272 is controlled by a second protector signal 268 to be turned on or turned off. The charge or discharge of the battery 290 is determined according to the on or off state of the switches 271 and 272.

FIG. 3 is a functional block diagram depicting a charging-discharging control device of another prior art. The difference between the charging-discharging control devices of FIG. 1 (please refer to the FIG. 1) and FIG. 3 is that a selector 350 uses six transistors 360, 365, 370, 375, 380, 390, and six control signals C31, C32, C33, C34, C35 and C36 to form four switches. These switches control the charging-discharging paths of the first battery pack 120 and the second battery pack 130. For example, the transistor 360 and 365 form a switch for the charging path of the first battery pack 120, wherein the transistor 360 and 365 are controlled by the control signals C31 and C35 individually. The transistor 370 and 375 form a switch for the charging path of the second battery pack 130, and the transistor 370 and 375 are controlled by the control signals C32 and C36 individually. The transistor 380 and 365 form a switch for the discharging path of the first battery pack 120, and the transistor 380 and 365 are controlled by the control signals C33 and C35 individually. The transistor 390 and 375 form a switch for the discharging path of the second battery pack 130, and the transistor 390 and 375 are controlled by the control signals C34 and C36 individually.

The control module 355 in the selector 350 provides the control signals C31, C32, C33, C34, C35, and C36. Compared with FIG. 1, the single transistor 365 in FIG. 3 replaces the transistors 165 and 185 in FIG. 1; the single transistor 375 in FIG. 3 replaces the transistors 175 and 195 in FIG. 1.

According to the description above, the selectors of the prior arts use too many transistors with high cost and low charging and discharging efficiency. Furthermore, in the design of the battery packs of the prior art, when two battery packs of different voltages are connected to one selector, the influence these battery packs have on each other reduces the efficiency of the charging and the discharging processes. On the contrary, if these two battery packs are effectively isolated, the efficiency of charge and discharge can be improved. For example, the battery pack of the lower voltage is charged first, and then once these two battery packs have the same voltage they are simultaneously charged. Thus, the battery pack with a higher voltage discharges first, and then the two battery packs discharge simultaneously after these two battery packs have the same voltage. Therefore, a low cost charging-discharging control device, fewer transistors, higher efficiency and a function of effectively isolating the battery pack is needed.

### SUMMARY

It is therefore an aspect of the present invention to provide a charging-discharging control device with fewer transistors

It is therefore another aspect of the present invention to provide a charging-discharging control device that can effectively isolate the battery pack.

It is therefore another aspect of the present invention to provide a charging-discharging control device used in a portable device to reduce the cost and improve the charging and discharging efficiency.

According to one preferred embodiment of the present invention, the charging-discharging control device has a selector, a charging circuit coupled to the selector, and at least two battery packs separately coupled to the selector and the charging circuit. The selector has a controller and a discharging switch. When the controller input voltage is higher than a preset voltage, the controller generates a charge-discharge signal of a first voltage level, and when the controller input voltage is not higher than the preset voltage, the controller generates the charge-discharge signal of a second voltage level and the discharging switch is turned on. Each battery pack has a first switch, a second switch serially coupled to the first switch, a battery coupled to the second switch, and a switch controller coupled to the first switch, the second switch and the battery. When the charge-discharge signal of the first voltage level is received, the first switch is turned on, the second switch becomes an ideal diode and the charging circuit charges the battery. When the charge-discharge signal of the second voltage level is received, the first switch becomes the ideal diode, the second switch is turned on and the battery supplies power to a loading system.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a functional block diagram depicting a charging-discharging control device of the prior art;

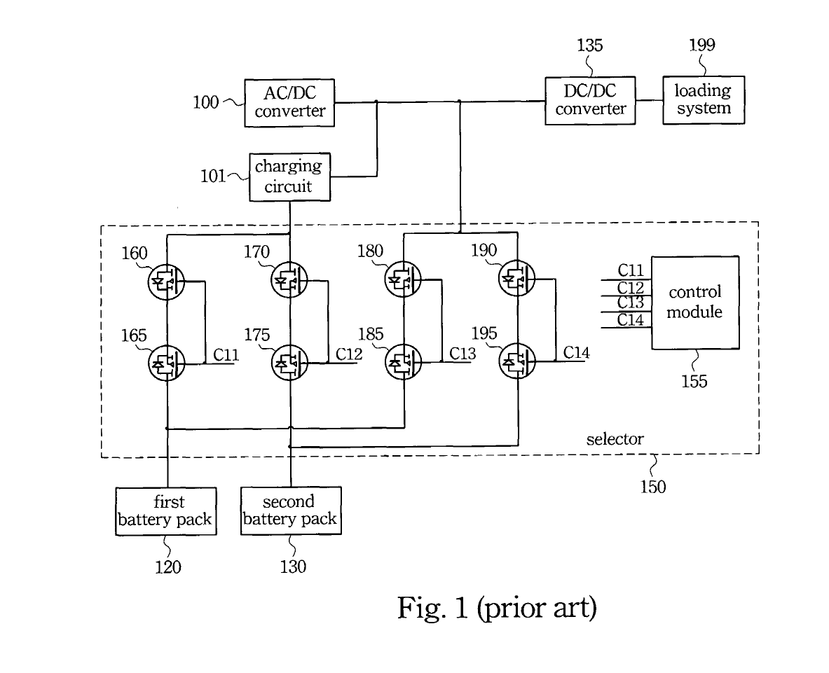

FIG. 2 is a functional block diagram depicting a battery pack of the prior art;

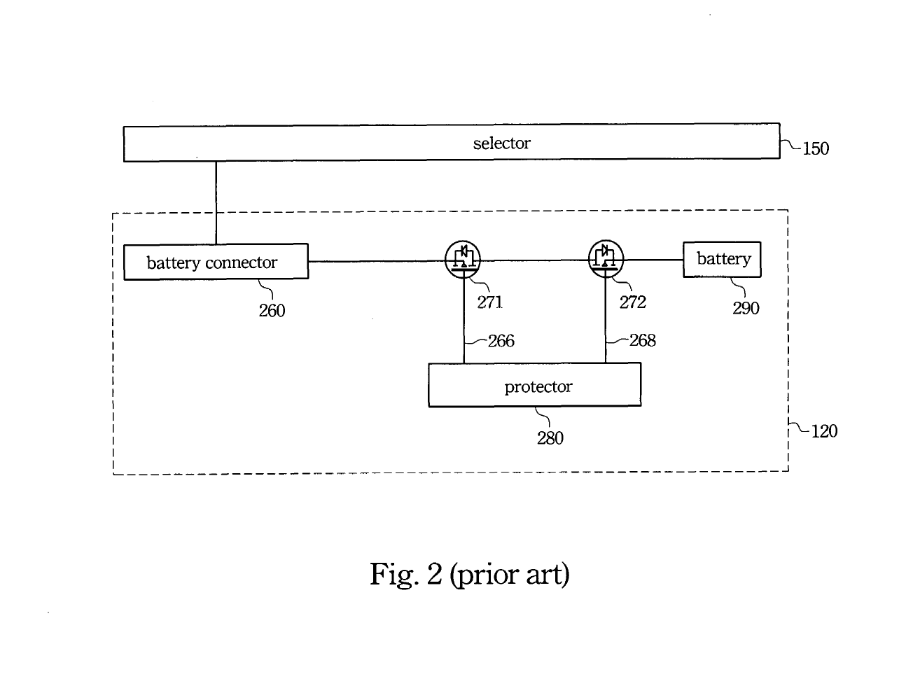

FIG. 3 is a functional block diagram depicting a charging-discharging control device of another prior art;

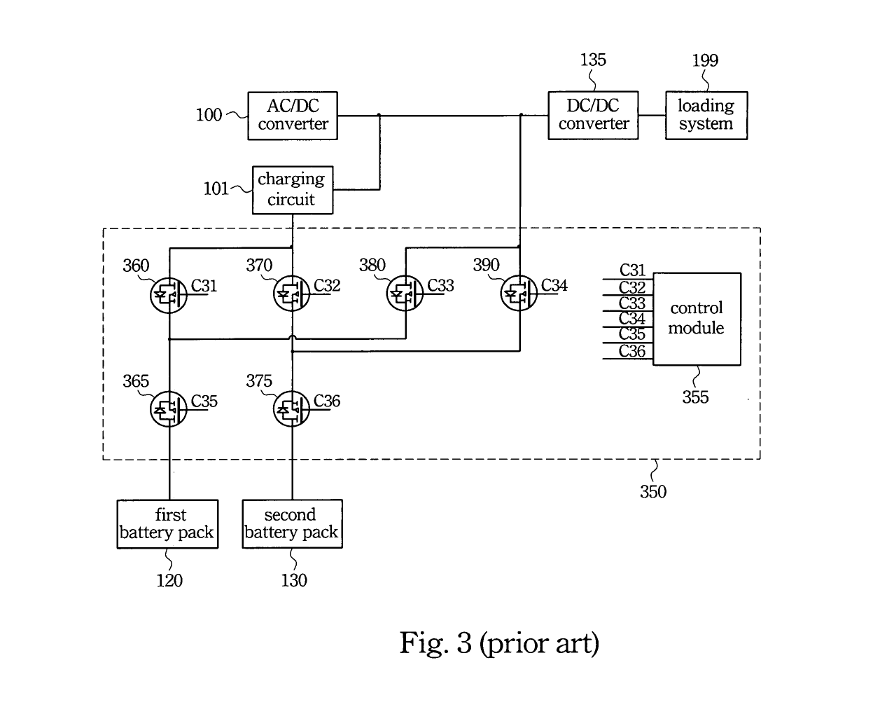

FIG. 4 is a functional block diagram depicting a charging-discharging control device of one preferred embodiment of the present invention;

FIG. 5 is a flow chart depicting a charge and discharging process of one preferred embodiment of the present invention;

FIG. 6 is a functional block diagram depicting a charging process of one preferred embodiment of the present invention;

FIG. 7 is a functional block diagram depicting a discharging process of one preferred embodiment of the present invention; and

FIG. 8 is a circuit diagram depicting a switch controller of one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

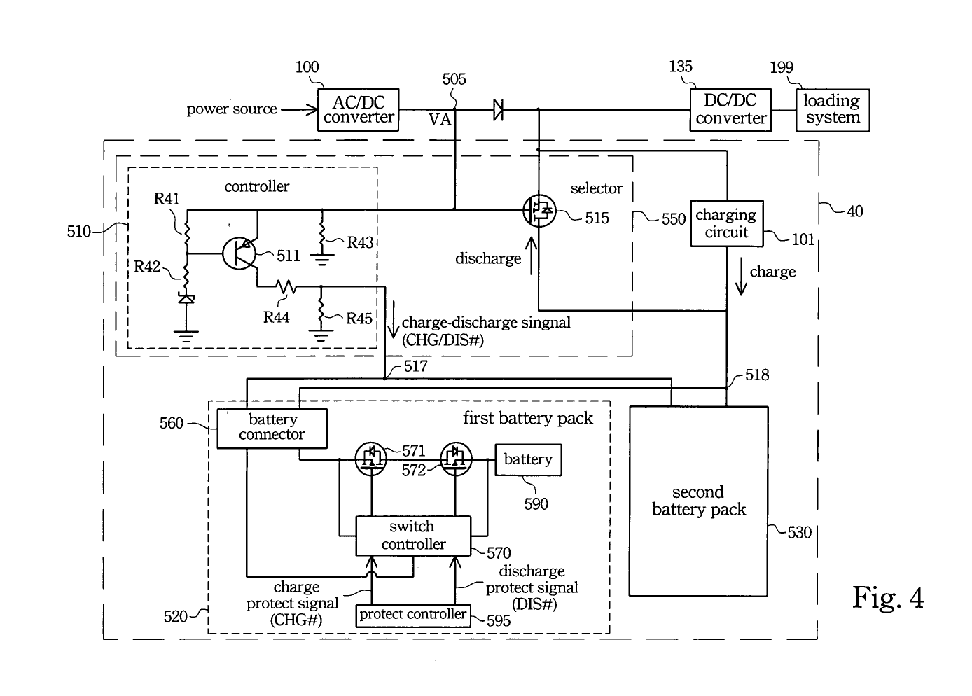

FIG. 4 is a functional block diagram depicting a charging-discharging control device 40 of one preferred embodiment of the present invention. The charging-discharging control device 40 has a selector 550, a charging circuit 101, a first battery pack 520, and a second battery pack 530. Wherein the selector 550 has a controller 510 and a discharging switch 515 and the selector 550 couples to an AC/DC converter 100 and a loading system 199 through a DC/DC converter 135.

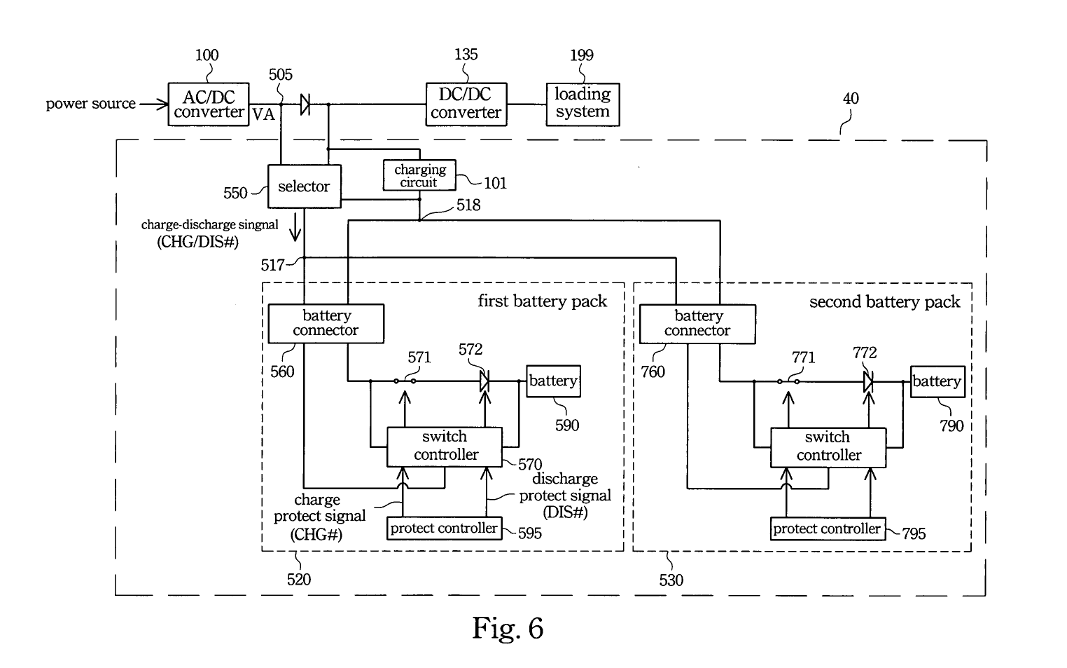

Referring to FIG. 6. FIG. 6 is a functional block diagram depicting a charging process of one preferred embodiment of the present invention. Please refer to simultaneously refer to FIG. 4. When the charging-discharging control device 40 couples to a power source, the AC/DC converter 100 transforms an AC current to a DC current, and a voltage VA is generated at the end 505.

When the voltage VA is higher than a preset voltage (such as 17.2 volts), the transistor 511 of the controller 510 in FIG. 4 is turned on and the controller 510 provides a charge-discharge signal of a high voltage level (CHG/DIS#=1). Thus the charge-discharge signal of a high voltage level (CHG/DIS#=1) is received by the first battery pack 520 and the second battery pack 530. Furthermore, when the charge protect signals (CHG#) provided by the protect controller 595 and 795 are low voltage levels (CHG#=0), the voltage of the battery 790 is higher than the voltage of the battery 590, and the voltage of the end 518 is higher than or equal to the voltage of the battery 590, the charging circuit 101 charges the battery 590.

After the voltage of the battery 590 is increased as the voltages of the battery 790, the charging circuit 101 charges the battery 590 and the battery 790 simultaneously. The switch 572 of the first battery pack 520 and the switch 772 of the second battery pack 530 become ideal diodes to prevent current leakage from the high voltage battery pack to the low voltage battery pack. Otherwise, when the charge protect signals (CHG#) provided by the protect controller 595 and 795 are high voltage levels (i.e. CHG#=1, such as the battery temperature or the battery voltage are too high), the charging circuit 101 will not charge the batteries.

Because the first battery pack 520 and the second battery pack 530 have identical architecture, hence the charging process can be described by when the charging circuit 101 charges the first battery pack 520. When the first battery pack 520 receives the charge-discharge signal of a high voltage level (CHG/DIS#=1), the charge-discharge signal of a high voltage level (CHG/DIS#=1) is transmitted to a switch controller 570 through a battery connector 560. The switch controller 570 turns the switch 571 on and makes the switch 572 an ideal diode illustrated in FIG. 6. When the charge protect signals (CHG#) provided by the protect controller 595 is a low voltage level (CHG#=0) and the voltage at the end 518 is higher than or equal to the voltage of the battery 590, the charging circuit 101 charges the battery 590 through the battery connector 560, the switches 571 and 572. When the charge protect signals (CHG#) provided by the protect controller 595 is a high voltage level (CHG#=1), the switches 571 and 572 become ideal diodes with opposite current directions to stop the charging circuit 101 charging the battery 590. Table 1 illustrates the charging process described above.

TABLE 1

| charge- | charge | discharge | | | |
|---|---|---|---|---|---|
| discharge | protect | protect | | | |
| signal | signal | signal | switch | switch | |
| (CHG/DIS#) | (CHG#) | (DIS#) | 571 | 572 | |
| 1 | 0 | X | ON | ideal | the charging |
| | | | | diode | circuit 101 |
| | | | | | charges the |
| | | | | | battery 590 |
| | | | | | through |
| | | | | | the switch 572 |
| 1 | 1 | X | ideal | ideal | stop the |
| | | | diode | diode | charging |
| | | | | | circuit 101 |
| | | | | | charging the |
| | | | | | battery 590 |

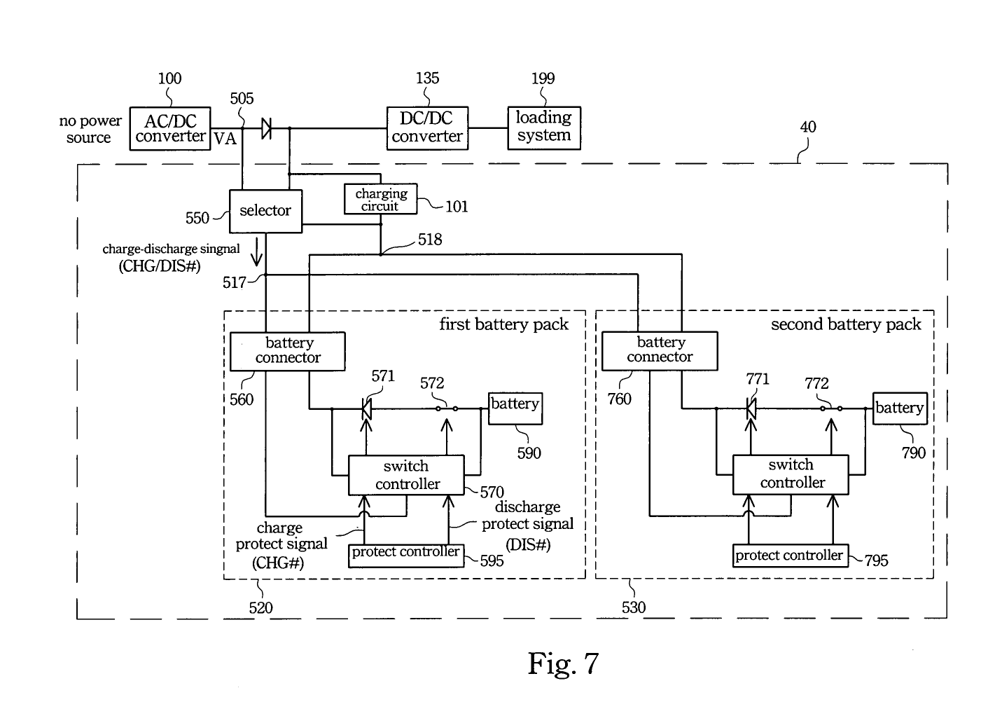

FIG. 7 is a functional block diagram depicting a discharging process of one preferred embodiment of the present invention. Please refer to FIG. 4 simultaneously. When the charging-discharging control device 40 is not coupled to a power source, the voltage VA is not higher than a preset voltage (such as 17.2 volts), the transistor 511 of the controller 510 in FIG. 4 is turned off and the discharging switch 515 is turned on. Hence the charge-discharge signal (CHG/DIS#) in the connection between the resistor R45 and the ground is a low voltage level (CHG/DIS#=0) signal. Thus the charge-discharge signal (CHG/DIS#) of a low voltage level (CHG/DIS#=0) is received by the first battery pack 520 and the second battery pack 530. Furthermore, when the discharge protect signals (DIS#) provided by the protect controller 595 and 795 are low voltage level (DIS#=0), the voltage of the battery 790 is higher than the voltage of the battery 590, and the voltage of the end 518 is lower than or equal to the voltage of the battery 590, the battery 590 supplies the power to the loading system 199 through the battery connector 560, the discharging switch 515 and the DC/DC converter 135.

The voltage of the battery 590 decreases as the voltages of the battery 790, the battery 590 and the battery 790 simultaneously supply power to the loading system 199. The switch 571 of the first battery pack 520 and the switch 771 of the second battery pack 530 become ideal diodes to prevent current leakage from the high voltage battery pack to the low voltage battery pack. Otherwise, when the discharge protect signals (DIS#) provided by the protect controller 595 and 795 are high voltage levels (i.e. DIS#=1, such as the battery temperature is too high or the battery voltage is too low), the battery packs will not discharge.

Because the first battery pack 520 and the second battery pack 530 have identical architecture, hence the discharging process can be described by when the first battery pack 520 supplies the power to the loading system 199. When the first battery pack 520 receives the charge-discharge signal of a low voltage level (CHG/DIS#=0), the charge-discharge signal of a low voltage level (CHG/DIS#=0) is transmitted to the switch controller 570 through the battery connector 560. The switch controller 570 makes the switch 571 an ideal diode and turns the switch 572 on as illustrated in the FIG. 7. When the discharge protect signals (DIS#) provided by the protect controller 595 is a low voltage level (DIS#=0) and the voltage of the end 518 is lower than or equal to the voltage of the battery 590, the battery 590 supplies power to the loading system 199 through the switches 571 and 572, the battery connector 560, the discharging switch 515 and the DC/DC converter 135. When the discharge protect signals (DIS#) provided by the protect controller 595 is a high voltage level (DIS#=1), the switches 571 and 572 become ideal diodes with opposite current directions to stop the battery 590 supplying power to the loading system 199. The table 2 illustrates the discharging process described above.

TABLE 2

| charge- | charge | discharge | | | |
|---|---|---|---|---|---|
| discharge | protect | protect | | | |
| signal | signal | signal | switch | switch | |
| (CHG/DIS#) | (CHG#) | (DIS#) | 571 | 572 | |
| 0 | X | 0 | ideal | ON | the battery |
| | | | diode | | 590 supplies |
| | | | | | the power |
| | | | | | to the loading |
| | | | | | system 199 |
| 0 | X | 1 | ideal | ideal | stop the |
| | | | diode | diode | battery 590 |
| | | | | | supplies the |
| | | | | | power |

According the description above, the selector 550 of the present invention has fewer transistors than the prior art to improve the efficiency of the charge and discharging processes.

Furthermore, from FIG. 6 and FIG. 7 above, when the residue voltages of the battery packs are different, the charging-discharging control device 40 makes the battery of with a lower residue voltage to be charged first. After the voltages of the two battery packs are the same, the charging-discharging control device 40 makes the two batteries to charge simultaneously. Thus, this device can effectively illustrate these two battery packs to improve the charging efficiency. By the same method, the charging-discharging control device 40 makes the battery with the higher residue voltage discharge first. After the voltages of the two battery packs are the same, the charging-discharging control device 40 makes the two batteries discharge simultaneously. By this way, the charging-discharging control device 40 can improve the discharging efficiency.

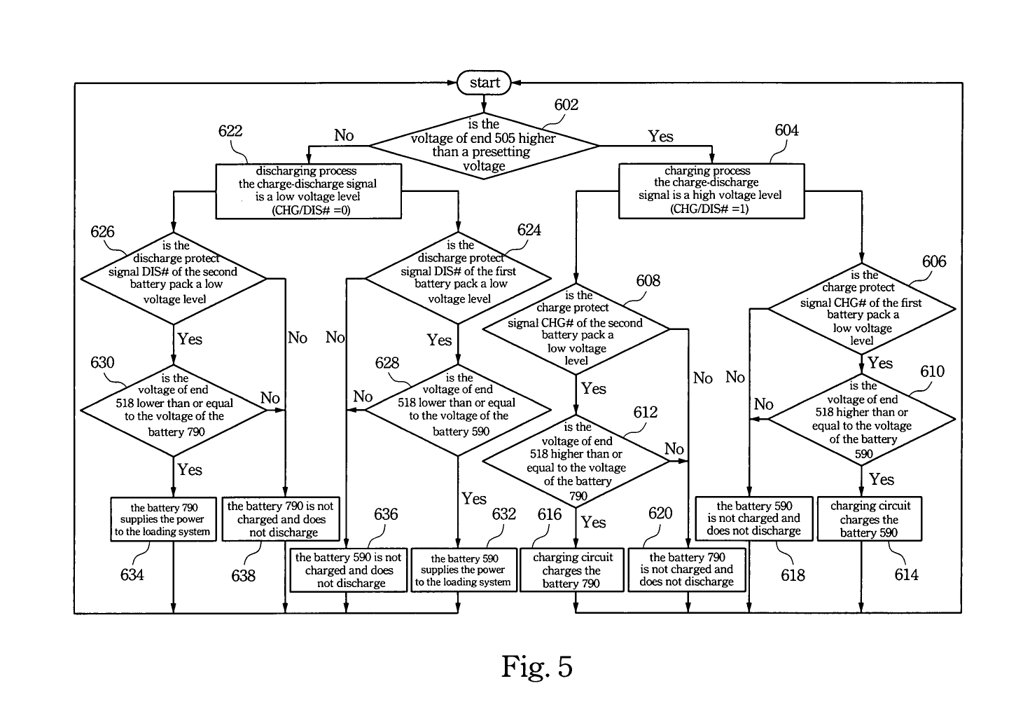

FIG. 5 is a flow chart depicting a charge and a discharging process of one preferred embodiment of the present invention. Please refer to the FIG. 6 and FIG. 7 simultaneously.

In Step 602 in FIG. 5, initially evaluates if the voltage of the end 505 is higher than the preset voltage (such as 17.2 volts). When the voltage of the end 505 is higher than a preset voltage, the charging process proceeds and the charge-discharge signal is a high voltage level (CHG/DIS#=1)(step 604). Step 606 individually evaluates if the charge protect signal (CHG#) of the first battery pack 520 is a low voltage level, and in Step 608 evaluates if the charge protect signal (CHG#) of the second battery pack 530 is a low voltage level. When the charge protect signal (CHG#) of the first battery pack 520 is a low voltage level (CHG#=0), Step 610 evaluates if the voltage of the end 518 is higher than or equal to the voltage of the battery 590. When the charge protect signal (CHG#) of the second battery pack 530 is a low voltage level (CHG#=0), Step 612 evaluates if the voltage of the end 518 is higher than or equal to the voltage of the battery 790. When the voltage of the end 518 is higher than or equal to the voltage of the battery 590, the charging circuit 101 charges the battery 590 (step 614). When the voltage of the end 518 is higher than or equal to the voltage of the battery 790, the charging circuit 101 charges the battery 790 (step 616). On the other side, when the charge protect signal (CHG#) of the first battery pack 520 is a high voltage level (CHG#=1) or the voltage of the end 518 is lower than the voltage of the battery 590, the battery 590 is not charged and does not discharge (step 618). When the charge protect signal (CHG#) of the second battery pack 530 is a high voltage level (CHG#=1) or the voltage of the end 518 is lower than the voltage of the battery 790, the battery 790 is not charged and does not discharge (step 620).

When the voltage of end 505 is not higher than a preset voltage (such as 17.2 volts), the discharging process proceeds and the charge-discharge signal is a low voltage level (CHG/DIS#=0) (step 622). Then, Step 624 individually evaluates if the discharge protect signal (DIS#) of the first battery pack 520 is a low voltage level, and Step 626 evaluates if the discharge protect signal (DIS#) of the second battery pack 530 is a low voltage level. When the charge protect signal (DIS#) of the first battery pack 520 is a low voltage level (DIS#=0), step 628 evaluates if the voltage of the end 518 is lower than or equal to the voltage of the battery 590. When the discharge protect signal (DIS#) of the second battery pack 530 is a low voltage level (DIS#=0), Step 630 evaluates if the voltage of the end 518 is lower than or equal to the voltage of the battery 790. When the voltage of the end 518 is lower than or equal to the voltage of the battery 590, the battery 590 supplies the power to the loading system 199 (step 632). When the voltage of the end 518 is lower than or equal to the voltage of the battery 790, the battery 790 supplies the power to the loading system 199 (step 634). On the other side, when the discharge protect signal (DIS#) of the first battery pack 520 is a high voltage level (DIS#=1) or the voltage of the end 518 is higher than the voltage of the battery 590, the battery 590 is not charged and does not discharge (step 636). When the discharge protect signal (DIS#) of the second battery pack 530 is a high voltage level (DIS#=1) or the voltage of the end 518 is higher than the voltage of the battery 790, the battery 790 is not charged and does not discharge (step 638).

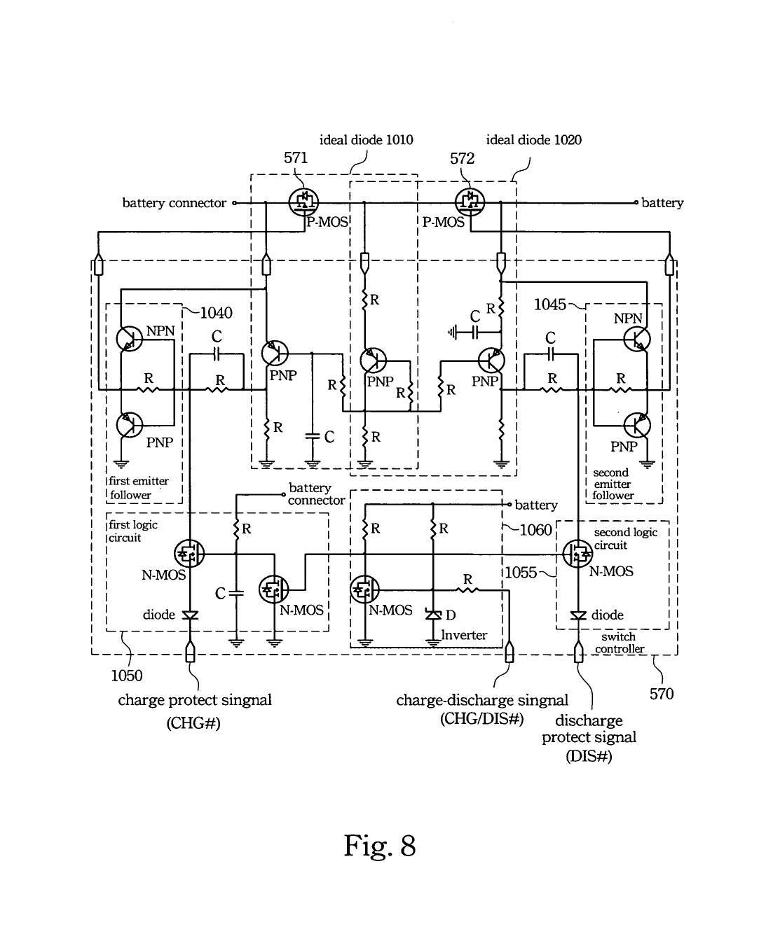

FIG. 8 is a circuit diagram depicting a switch controller of one preferred embodiment of the present invention. The switch controller 570 has an ideal diode 1010, a ideal diode 1020, a first emitter follower 1040, a second emitter follower 1045, a first logic circuit 1050, a second logic circuit 1055 and an inverter 1060. Wherein the function of the first emitter follower 1040 improves the output current and speeds up the turn on and turn off of the switch 571. The functions of the second emitter follower 1045 improves the output current and speeds up the turn on and turn off of the switch 572. The function of the inverter 1060 inverts the charge-discharge signal CHG/DIS# to be CHG#/DIS.

According to the first logic circuit 1050 and the table 1, when the charge-discharge signal (CHG/DIS#) is a high voltage level (CHG/DIS#=1) and the charge protect signal is a low voltage level (CHG#=0), the switch 571 is turned on, the switch 572 is an ideal diode and the charging process proceeds. When the charge-discharge signal (CHG/DIS#) is a high voltage level (CHG/DIS#=1) and the charge protect signal is a high voltage level (CHG#=1), the switches 571 and 572 are ideal diodes and the charging process stops.

According to the second logic circuit 1055 and table 2, when the charge-discharge signal (CHG/DIS#) is a low voltage level (CHG/DIS#=0) and the discharge protect signal is a low voltage level (DIS#=0), the switch 572 is turned on, the switch 571 is an ideal diode and the discharging process proceeds. When the charge-discharge signal (CHG/DIS#) is a low voltage level (CHG/DIS#=0) and the discharge protect signal is a high voltage level (DIS#=1), the switches 571 and 572 are ideal diodes and the discharging process stops.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A charging-discharging control device, comprising:
a selector, comprising:
a controller, wherein when a controller input voltage is higher than a preset voltage, the controller generates a charge-discharge signal of a first voltage level, and when the controller input voltage is not higher than the preset voltage, the controller generates the charge-discharge signal of a second voltage level; and
a discharging switch, wherein when the controller input voltage is not higher than the preset voltage, the discharging switch is turned on; a charging circuit coupled to the selector; and
at least two battery packs separately coupled to the selector and the charging circuit, wherein each of the battery packs comprises:
a first switch;
a second switch serially coupled to the first switch;
a battery coupled to the second switch; and
a switch controller coupled to the first switch, the second switch, and the battery, wherein when receiving the charge-discharge signal of the first voltage level, the first switch is turned on, the second switch becomes an ideal diode and the charging circuit charges the battery, and when receiving the charge-discharge signal of the second voltage level, the first switch becomes the ideal diode, the second switch is turned on and the battery supplies power to a loading system.

2. The charging-discharging control device as claimed in claim 1, wherein when receiving the charge-discharge signal of the first voltage level and the batteries of the battery packs have different voltages, the charging circuit charges the battery with lowest voltage of the battery packs.

3. The charging-discharging control device as claimed in claim 1, wherein when receiving the charge-discharge signal of the first voltage level and the batteries of the battery packs have equivalent voltages, the charging circuit charges each battery of the battery packs.

4. The charging-discharging control device as claimed in claim 1, wherein each of the battery packs further comprises:
a protect controller coupled to the switch controller, wherein when the protect controller outputs a charge protect signal to the switch controller under a specific condition, the first switch and the second switch become ideal diodes with different current directions and the charging circuit does not charge the battery.

5. The charging-discharging control device as claimed in claim 4, wherein the specific condition is that the temperature of the battery is overheated or the voltage of the battery is too high.

6. The charging-discharging control device as claimed in claim 1, wherein the first voltage level is a high voltage level.

7. The charging-discharging control device as claimed in claim 1, wherein when receiving the charge-discharge signal of the second voltage level and the batteries of the battery packs have different voltages, the battery with the highest voltage of the battery packs supplies the power to the loading system.

8. The charging-discharging control device as claimed in claim 1, wherein when receiving the charge-discharge signal of the second voltage level and the batteries have equivalent voltages, each battery supplies power to the loading system.

9. The charging-discharging control device as claimed in claim 1, wherein each of the battery packs further comprises:
a protect controller coupled to the switch controller, wherein when the protect controller outputs a discharge protect signal to the switch controller under a specific condition, the first switch and the second switch become ideal diodes with different current directions and the battery does not supply the power to the loading system.

10. The charging-discharging control device as claimed in claim 9, wherein the specific condition is that the temperature of the battery is overheated or the voltage of the battery is too high.

11. The charging-discharging control device as claimed in claim 1, wherein the second voltage level is a low voltage level.
